(19) United States
(12) Patent Application Publication
(10) Pub. No.: US 2015/0350028 A1
(43) Pub. Date: Dec. 3, 2015

(54) ARRANGEMENT FOR REMOTELY MANAGING COMPUTER SYSTEMS

(71) Applicant: Devilabs Oy, Turku (FI)

(72) Inventor: Markus Leinonen, Turku (FI)

(73) Assignee: Devilabs Oy, Turku (FI)

(21) Appl. No.: 14/288,912

(22) Filed: May 28, 2014

(51) Int. Cl. H04L 12/24; H04L 29/08; G06F 3/0484

(52) U.S. Cl. CPC H04L 41/22; G06F 3/04842; G06F 3/04847; H04L 67/02; H04L 67/10

(57) ABSTRACT

A method for operating a computer management system includes providing management instructions for at least a first managed computer system in an upper layer of a display, and providing a user interface of the first managed computer system in a lower layer of the display.

### TECHNICAL FIELD

The presently disclosed embodiments relate to management of computer systems, and more specifically relate to remote management of computer systems.

### BACKGROUND

System management is an area of Information Technology (IT) that concerns configuring and managing computer resources, especially network resources. System management tasks include tasks related to both hardware and software, e.g. migration, data center management, data center surveillance, device configuration, virtualization, integration etc. applied to networking devices, server products, storage systems and so forth. Generally, the computer and network resources of an IT system are managed by corresponding IT personnel using remote management systems.

FIG. 1 is a schematic illustration of remote management of a first computer system 100 by a user 104 of a second computer system 102. The remote management capability is arranged over Remote Desktop Protocol (RDP), which essentially displays a user interface (UI) of the first computer system 100 on the second computer system 102 for remote management over a communication network 106. RDP is a proprietary protocol by Microsoft™ and requires RDP server software 110 running on the first computer system 100 and RDP client software 112 running on the second computer system 102.

An alternative to RDP is webRDP, a proprietary protocol by Lenovo™, where webRDP provides secure, remote access to Terminal Servers and Windows programs from any web browser. The webRDP protocol uses Hypertext Markup Language version 5 (HTML5) specifications and WebSocket, standardized by the IETF as RFC 6455, specifications, and eliminates the need for specific RDP client software on the second computer system 102. Only a HTML5 capable web browser is needed on the client side, i.e. on the second computer system 102 for remote management of the first computer system 100. The advantage of using the webRDP is that the UI of the first computer system 100 can be operated on any device with an HTML5 capable browser, including tablets and even smartphones, and multiple UI views to different computer systems can be handled in separate browser windows, tabs or the like, on a single computer system.

In spite of the capabilities and availability of remote management systems, managing computer systems is often a complex task. For example, migration from an old computer system to a new one is a critical task, because even though the functionality of the “old” and “new” computer systems might be principally the same, their management user interfaces may not be similar. Further, the process of migration has to be executed from two different computer management systems remotely, which is cumbersome and prone to errors. Also, the user may not be trained to execute the task of migration from old to new computer systems, and may have to refer to various manuals separately for instructions and steps regarding the migration task.

Thus, there is a need for a computer management system that allows users to execute system management tasks conveniently without any errors, and that trains the users to execute similar management tasks in the future.

### SUMMARY

The present disclosure seeks to provide a computer implemented method for operating a computer management system.

The present disclosure also seeks to provide a computer management system.

In one aspect, embodiments of the present disclosure provide a method for operating a computer management system that includes providing management instructions for at least a first managed computer system in an upper layer of a display, and providing a user interface of the first managed computer system in a lower layer of the display.

In an embodiment of the present disclosure, the upper layer is movable within the display.

In an embodiment of the present disclosure, the method further includes providing the display through a web browser.

In an embodiment of the present disclosure, the method further includes providing the display using a hypertext transfer protocol.

In an embodiment of the present disclosure, the method further includes providing a selection of one or more second managed computer systems in the upper layer, and upon selection of one of the second managed computer systems, providing management instructions for the selected second managed computer system in the upper layer of the display, and providing a user interface of the selected second managed computer system in the lower layer of the display.

In an embodiment of the present disclosure, the method further includes providing a single logon for the first managed computer system and the second managed computer systems.

In another aspect, embodiments of the present disclosure provide a computer management system, that includes a processor; and program code stored on a non-transitory computer readable medium. The processor and program code are configured to cause the apparatus to provide management instructions for at least one first managed computer system in an upper layer of a display, and provide a user interface of the at least one managed computer system in a lower layer of the display.

In an embodiment of the present disclosure, the processor and program code are configured to cause the upper layer to be movable within the display.

In an embodiment of the present disclosure, the processor and program code are configured to cause the apparatus to provide the display through a web browser.

In an embodiment of the present disclosure, the processor and program code are configured to cause the apparatus to provide the display using a hypertext transfer protocol.

In an embodiment of the present disclosure, the processor and program code are configured to cause the apparatus to provide a selection of one or more second managed computer systems in the upper layer, and upon selection of one of the second managed computer systems, provide management instructions for the selected managed computer system in the upper layer of the display, and provide a user interface of the selected second managed computer system in the lower level of the display.

In an embodiment of the present disclosure, the processor and program code are configured to cause the apparatus to provide a single logon for the first managed computer system and the second managed computer systems.

In yet another aspect, embodiments of the present disclosure provide a computer management system that includes a plurality of managed computer systems, a management gateway coupled to the plurality of managed computer systems through a remote management client, a portal webserver coupled to the management gateway and configured to grant access to the plurality of managed systems and to provide a layered display to a user device, the display comprising an upper layer of management instructions for a first one of the managed systems and a lower layer of content from the first managed system.

In an embodiment of the present disclosure, the portal webserver is configured to cause the upper layer to be movable within the display.

In an embodiment of the present disclosure, the portal webserver is configured to provide the layered display through a web browser.

In an embodiment of the present disclosure, the portal webserver is configured to provide the layered display using a hypertext transfer protocol.

In an embodiment of the present disclosure, the portal webserver is configured to provide a selection of one or more second managed computer systems in the upper layer, and upon selection of one of the second managed computer systems, provide management instructions for the selected second managed computer system in the upper layer of the display; and provide a user interface of the selected second managed computer system in the lower level of the display.

In an embodiment of the present disclosure, the processor and program code are configured to cause the apparatus to provide a single logon for the first managed computer system and the second managed computer systems.

Embodiments of the present disclosure enable the user to remotely manage at least one computer system from their computer screen, and simultaneously receive instructions/help regarding the management process on the computer screen, thus greatly alleviating tasks related to computer system management, and training users to perform computer system management tasks. Along with a user interface of a computer system to be managed, the user can see step by step guidance for executing system management tasks conveniently without any errors, while getting trained to execute similar management tasks in future. The disclosed embodiments may advantageously utilize a UI protocol flow, like RDP, from two or more computer systems, specifically to be presented (over http protocol) on a single computer, attached with a dynamic control/information flow.

### BRIEF DESCRIPTION OF THE FIGURES

The summary above, as well as the following detailed description of illustrative embodiments, is better understood when read in conjunction with the appended drawings. For the purpose of illustrating the present disclosure, example constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of remote management of a computer system;

FIGS. 2a and 2b are schematic illustrations of a computer management system, in accordance with various embodiments of the present disclosure;

FIG. 3 is a schematic illustration of management of the managed computer systems by the user, in accordance with an embodiment of the present disclosure;

FIG. 4 is an illustration of an exemplary task view page displayed on the user computing device, upon login into the management portal computer system, in accordance with the present disclosure;

FIGS. 5-7 are illustrations of exemplary displays of the user computing device upon selection of at least one managed computer system and a system management task, in accordance with the present disclosure; and

FIG. 8 is an illustration of a method for operating the computer management system, in accordance with the present disclosure.

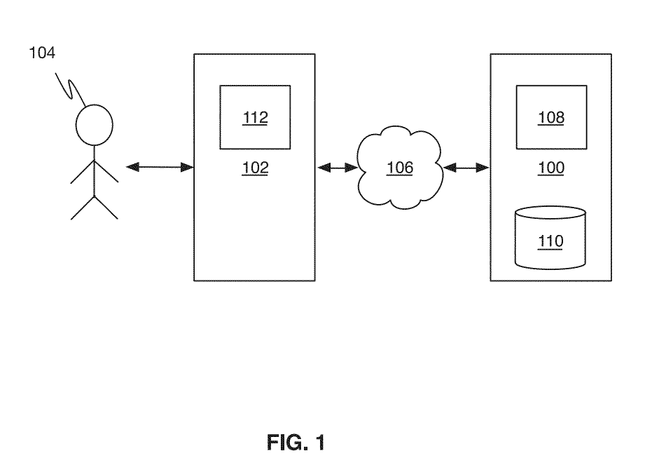

### DETAILED DESCRIPTION

The following detailed description illustrates embodiments of the present disclosure and methods by which they can be implemented. Although the best mode of carrying out the present disclosure has been disclosed, those skilled in the art would recognize that other embodiments for carrying out or practicing the present disclosure are also possible.

Embodiments of the present disclosure provide a computer-implemented method for operating a computer management system. The computer-implemented method includes providing management instructions for at least a first managed computer system in an upper layer of a display, and providing a user interface of the first managed computer system in a lower layer of the display.

Additionally, there is provided a computer management system that includes a plurality of managed computer systems, a management gateway coupled to the plurality of managed computer systems through a remote management client, a portal webserver coupled to the management gateway and configured to grant access to the plurality of managed systems and to provide a layered display to a user device, the display comprising an upper layer of management instructions for a first one of the managed systems and a lower layer of content from the first managed system.

Embodiments of the present disclosure substantially eliminate, or at least partially address, problems in the prior art, enabling the user to remotely manage at least one computer system and simultaneously receive instructions/help regarding the management process on their computer screen.

Modifications to embodiments of the present disclosure described herein are possible without departing from the scope of the present disclosure as defined by the accompanying claims. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

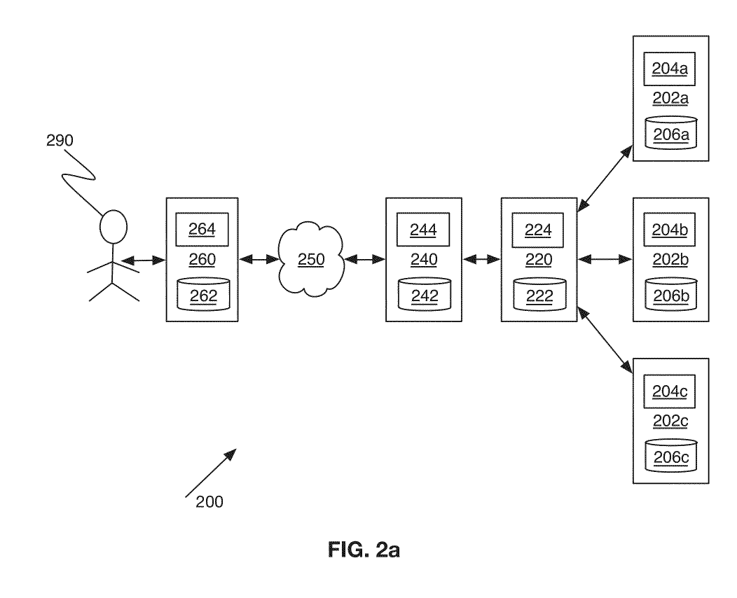

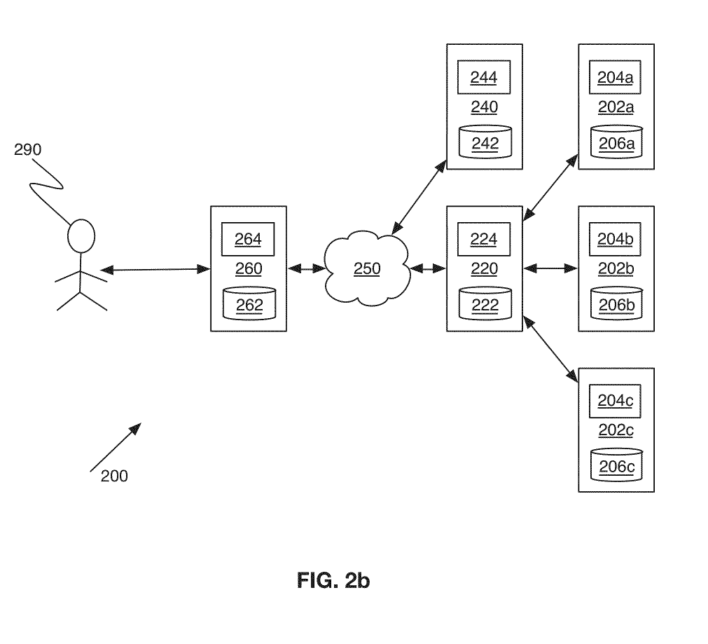

Referring now to the drawings, particularly by their reference numbers, FIGS. 2a and 2b are schematic illustrations of a computer management system 200, in accordance with various embodiments of the present disclosure. The computer management system 200 includes first, second and third managed computer systems 202a, 202b and 202c (hereinafter collectively referred to as managed computer systems 202), each executing management software 204a, 204b and 204c respectively for enabling a user to manage the managed computer systems 202. In an embodiment of the present disclosure, a managed computer system 202 includes one or more computer systems that share the same management user interface. In another embodiment of the present disclosure, the managed computer systems 202 may belong to an IT system and system management tasks such as migration, data center management, data center surveillance, device configuration, virtualization, integration may be applied to them.

The first, second and third managed computer systems 202a, 202b, and 202c includes first, second and third remote desktop server software 206a, 206b, and 206c respectively, for making the user interfaces of the managed computer systems 202 remotely available using one of a Remote Desktop Protocol (RDP), Virtual Network Computing (VNC), or the like.

The computer management system 200 further includes a management gateway 220 coupled to the managed computer systems 202, a portal webserver 240 coupled to the management gateway 220, and a user computing device 260 operated by an end user 290 for executing one or more system management tasks on the managed computer systems 202. The managed computer systems 202, the management gateway 220, the portal webserver 240, and the user computing device 260, are generally computers communicatively coupled to each other over a communication network 250. Examples of the communication network 250, include, but are not limited to Internet, Intranet, Local Area Network (LAN), and Wide Area Network (WAN).

The user computing device 260 is generally representative of user computing devices such as a personal computer, laptop, personal digital assistant, tablet, phablet, webpad, wearable computer, mobile telephone, wrist-worn computer, smart phone, and includes an operating system 262 and a web browser 264, which may be HTML5 capable. The user 290 may be at least one of: end users, resellers/IT outsourcers, Independent Software Vendors (ISVs), and IT administrators. The user computing devices include a central processing unit, memory, a communication interface, an input device and a physical display for rendering a user interface to be presented to users. In this disclosure the term display refers to user interface elements that are rendered on a physical display, like CRT (Cathode Ray Tube), LCD (Liquid Crystal Display), video projector.

The management gateway 220 runs an operating system 222, and remote desktop gateway software 224, such as webRDP or other similar software for enabling remote access to the managed computer systems 202. The portal webserver 240 runs an operating system 242 and web server software 244.

The web server software 244 executing on the portal webserver 240 essentially grants and enables access to the managed computer systems 202, and provides a layered display to the user computing device 260 through the web browser 264 using a hypertext transfer protocol. The layered display includes an upper layer and a bottom layer, wherein the upper layer is movable within the display. The upper layer includes management instructions for executing a management task on a managed computer system 202, and the lower layer includes a user interface of the managed computer system 202. In an embodiment of the present disclosure, the management gateway 220 and the portal webserver 240 are preconfigured to suit the needs of the user 290, such that no browser plug-ins are required therein.

FIG. 2a illustrates one embodiment, in which the network traffic between the user computing device 260 and the managed computer systems 202 is routed via the portal webserver 240. FIG. 2b illustrates another embodiment, in which the network traffic between the user computing device 260 and the managed computer systems 202 is routed only via the management gateway 220. In both cases the network traffic utilizes Hypertext Transfer Protocol Secure (HTTPS) protocol, thereby providing better security.

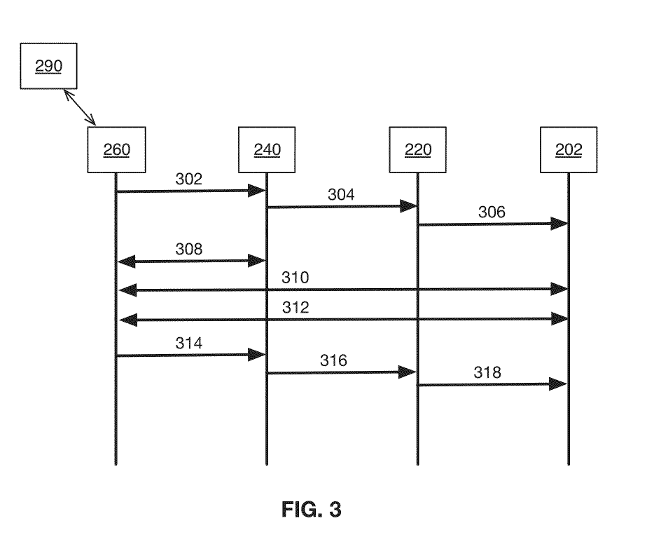

FIG. 3 is a schematic illustration of management of two managed computer systems 202 by the user 290 using the user computing device 260, in accordance with an embodiment of the present disclosure. Step 302 represents connecting the user computing device 260 and the portal webserver 240. To initiate a connection, the end user 290 enters a web address of the portal webserver 240 in respective web browser 264. Upon entering of the web address in the web browser 264, the portal webserver 240 displays a login page on a display of the user computing device 260 for allowing the user to enter their login details. In an embodiment of the present disclosure, the portal webserver 240 grants access and privileges to the gateway computer system 220 and the managed computer systems 202 in a user specific single sign-on manner.

After the user logins into the portal webserver 240, they are allowed to select a system management task from a list of system management tasks. After the user selects the management task, the portal webserver 240 provides a layered display to the user computing device 260, which includes an upper layer and at least one bottom layer. In an example, when the end user 290 selects a system management task, a HTML5/JavaScript code is activated that creates the upper and a bottom layer on the display of the user computing device 260. The upper layer is an HTML5 page containing task specific controls and area for management instructions, whereas the bottom layer is an empty HTML5 frame for receiving data from the management gateway 220 over WebSockets.

Step 304 represents connecting the portal webserver 240 and the management gateway 220. Upon establishing a connection between the user computing device 260 and the portal webserver 240, the portal webserver 240 opens at least one WebSocket to the management gateway 220 to exchange data between the user computing device 260 and the management gateway 220. In an example, during step 304, the portal webserver 240 opens the connection to the management gateway 220, and instructs the management gateway 220 to invoke the managed computer systems 202 in order to be remotely managed over RDP.

Step 306 represents connecting the management gateway 220 and the managed computer systems 202. Upon establishment of the connection between the portal webserver 240 and the management gateway 220, the management gateway 220 establishes RDP management sessions for the managed computer systems 202 and connects them to the at least one bottom layers over webRDP or other similar software. In an embodiment of the present disclosure, an RDP over HTTP protocol converter is initiated on the management gateway 220 for feeding data from the managed computer systems 202 to the bottom layer of the layered display on the user computing device 260.

Step 308 represents a connection between the web browser 264 of the user computing device 260 and the portal webserver 240, wherein the upper layer of the layered display of the user computing device 260 receives management instructions for executing a system management task on at least one managed computer system 202 from the portal webserver 240.

Steps 310 and 312 represent connections between the web browser 264 of the user computing device 260 and the managed computer systems 202, for displaying the user interfaces of at least one managed computer system 202 in the lower layer of the layered display. In an embodiment of the present disclosure, the upper layer is configured to enable the user to select a managed computer system 202 from available managed computer systems 202, and upon selection of the managed computer system 202, the upper layer is configured to provide management instructions for executing the selected management task on the managed computer system 202. The bottom layer is configured to display the user interface of the selected managed computer system 202. Upon receiving the user interface of the managed computer system 202 and the corresponding management instructions on a single display, the user 290 can conveniently execute a corresponding system management task.

Step 314 represents ending the management session between the user computing device 260 and the portal webserver 240, whereupon in step 316 the portal webserver 240 ends the management session between the portal webserver 240 and the management gateway 220, whereupon in step 318 the management gateway 220 ends the management session between the management gateway 220 and the managed computer system 202.

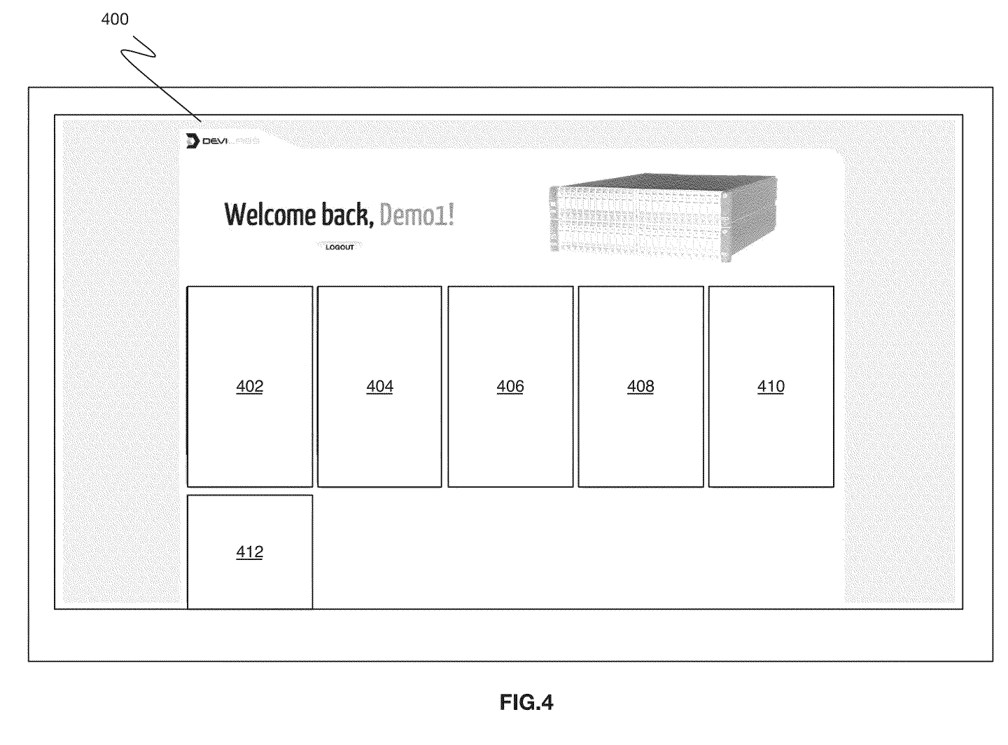

FIG. 4 is an illustration of an exemplary task view page 400 displayed on the user computing device 260, when the user 290 logins into the portal webserver 240. The task view page 400 enables the user 290 to select one of system management tasks 402, 404, 406, 408, 410 and 412. In an example, the system management task 406 is the one selected by the user. Examples of system management tasks, include tasks related to both hardware and software, e.g. migration, data center management, data center surveillance, device configuration, virtualization, integration etc. applied to networking devices, server products, storage systems and so forth.

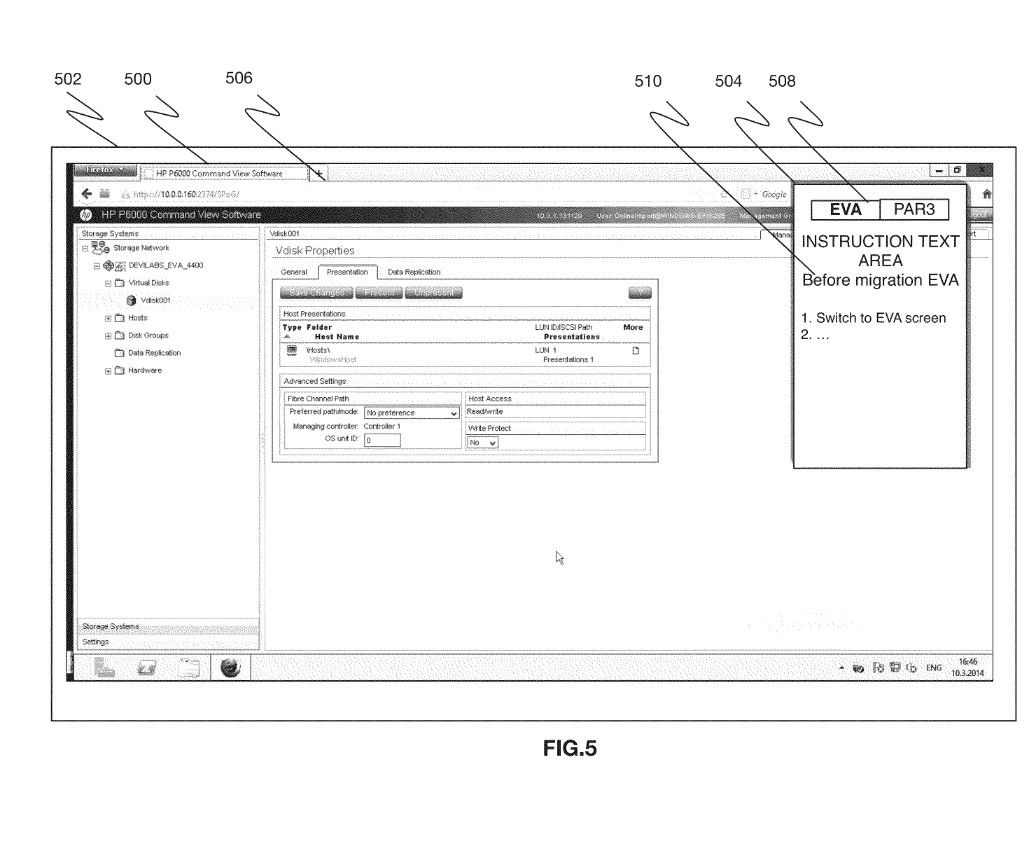

FIG. 5 is an illustration of an exemplary display 500 of a user computing device 502 (an example of the user computing device 260) upon user selection of a system management task for a first managed computer system 202a. The display 500 includes an upper layer 504 and a bottom layer 506. The upper layer 504 displays a management view selector 508 and management instructions 510 for executing the selected system management task on the first managed computer system 202a. The upper layer 504 is essentially a separate window that can be moved around, and is configured to stay on top all the time. The bottom layer 506 displays the user interface of the first managed computer system 202a. In one embodiment of the present disclosure, the computing device 502 retrieves and caches the task specific instructions locally.

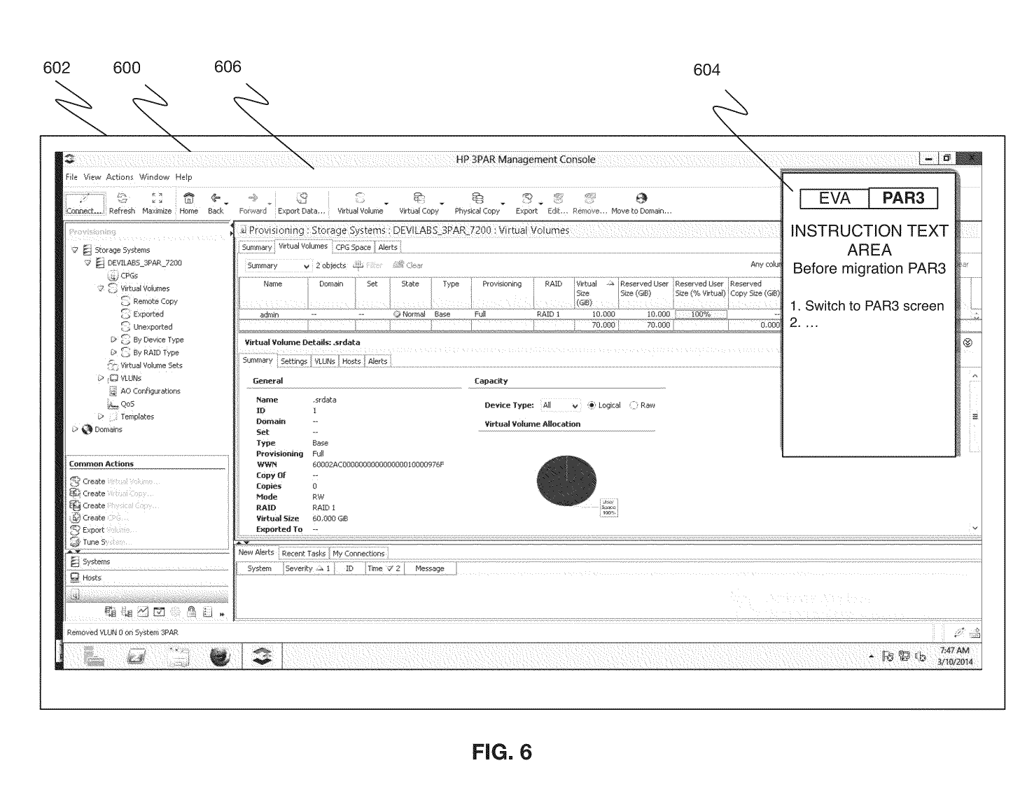

FIG. 6 is an illustration of an exemplary display 600 of the user computing device 602 upon user selection of a system management task for a second managed computer system 202b. The display 600 includes an upper layer 604 including management instructions for executing the selected system management task on the second managed computer system 202b. The bottom layer 606 includes the user interface of the second managed computer system 202b.

FIGS. 5 and 6 essentially illustrate a practical example snippet of a migration process from the first managed computer system 202a to the second managed computer system 202b, managed by the user 290 on the user computing device 502 using separate web browser windows. In an example, the first managed computer system 202a is a discontinued Hewlett-Packard EVA server system, and the second managed computer system 202b is a new Hewlett-Packard 3PAR server system. By clicking on the EVA/3PAR button, the bottom layer view changes and accordingly the upper layer contents change.

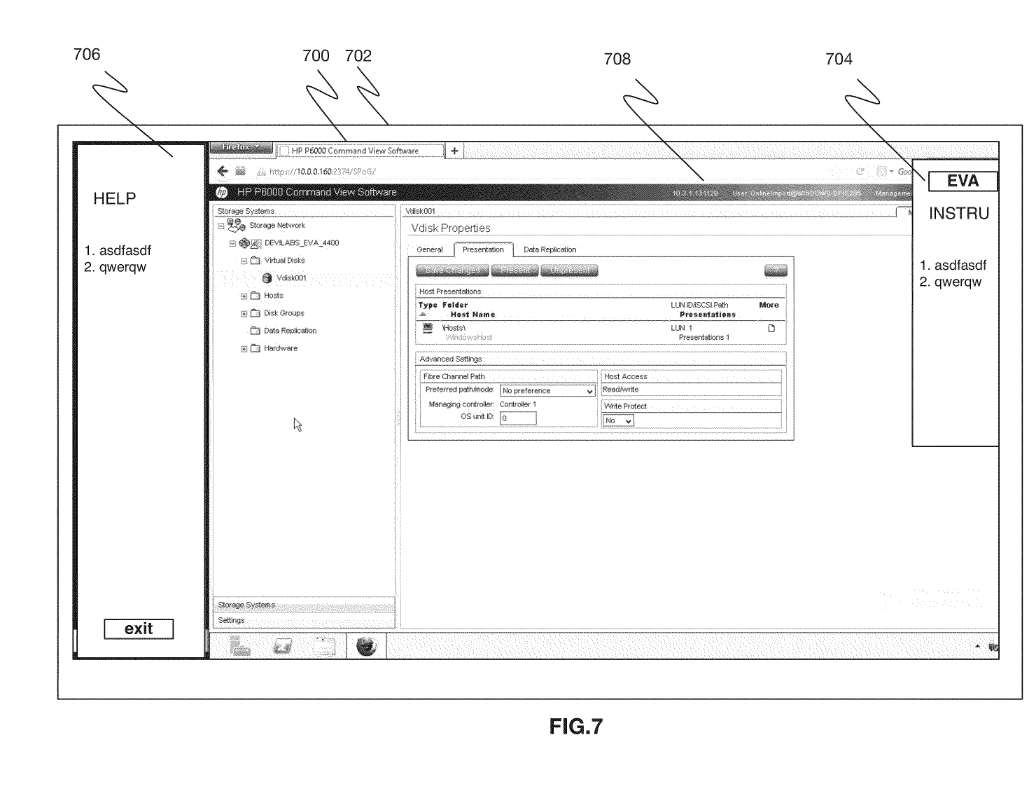

FIG. 7 is an illustration of an exemplary display 700 of a user computing device 702 (an example of the user computing device 260) upon user selection of a system management task for a managed computer system 202. The display 700 includes an upper layer 704, an upper layer sliding help window 706, and a bottom layer 708.

The upper layer sliding window 706 is normally invisible, but becomes visible when the cursor is moved to a left edge of the display 700, such that the upper layer sliding help window 706 slides in from the left and other layers 702 and 706 are moved respectively to the right. In an embodiment of the present disclosure, the upper layer sliding window 706 may include additional sources of information, for example, a chat option with a help personnel.

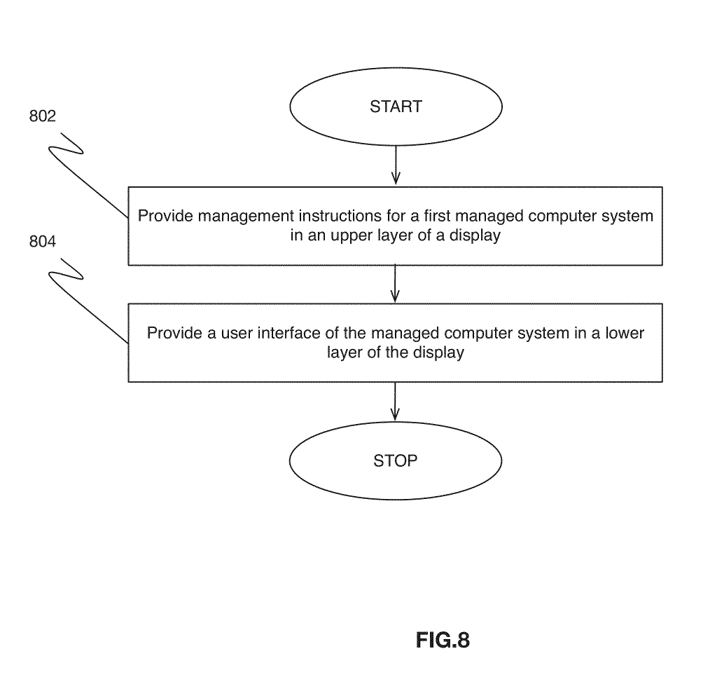

FIG. 8 is an illustration of steps of a method for operating the computer management system 200, in accordance with the present disclosure. The method is depicted as a collection of steps in a logical flow diagram, which can be implemented using a variety of means.

At step 802, management instructions are provided for a first managed computer system in an upper layer of a display.

At step 804, a user interface of the managed computer system is provided in a lower layer of the display.

It should be noted here that the steps 802 to 804 are only illustrative and other alternatives can also be provided where one or more steps are added, one or more steps are removed, or one or more steps are provided in a different sequence without departing from the scope of the claims herein.

While the disclosure has been presented with respect to certain specific embodiments, it will be appreciated that many modifications and changes may be made by those skilled in the art without departing from the spirit and scope of the disclosure. It is intended, therefore, by the appended claims to cover all such modifications and changes as fall within the true spirit and scope of the disclosure.

What is claimed is:

1. A method for operating a computer management system, comprising:
providing management instructions for at least a first managed computer system in an upper layer of a display; and
providing a user interface of the first managed computer system in a lower layer of the display.

2. The method of claim 1, wherein the upper layer is movable within the display.

3. The method of claim 1, further comprising providing the display through a web browser.

4. The method of claim 3, further comprising providing the display using a hypertext transfer protocol.

5. The method of claim 1 further comprising:
providing a selection of one or more second managed computer systems in the upper layer; and
upon selection of one of the second managed computer systems:
providing management instructions for the selected second managed computer system in the upper layer of the display; and
providing a user interface of the selected second managed computer system in the lower layer of the display.

6. The method of claim 5 further comprising providing a single logon for the first managed computer system and the second managed computer systems.

7. A computer management system comprising:
a processor; and
program code stored on a non-transitory computer readable medium;
the processor and program code configured to cause the apparatus to:
provide management instructions for at least one first managed computer system in an upper layer of a display; and
provide a user interface of the at least one managed computer system in a lower layer of the display.

8. The computer management system of claim 7, wherein the processor and program code are configured to cause the upper layer to be movable within the display.

9. The computer management system of claim 7, wherein the processor and program code are configured to cause the apparatus to provide the display through a web browser.

10. The computer management system of claim 9, wherein the processor and program code are configured to cause the apparatus to provide the display using a hypertext transfer protocol.

11. The computer management system of claim 7, wherein the processor and program code are configured to cause the apparatus to:
provide a selection of one or more second managed computer systems in the upper layer; and
upon selection of one of the second managed computer systems:
provide management instructions for the selected managed computer system in the upper layer of the display; and
provide a user interface of the selected second managed computer system in the lower level of the display.

12. The computer management system of claim 11, wherein the processor and program code are configured to cause the apparatus to provide a single logon for the first managed computer system and the second managed computer systems.

13. A computer management system comprising:
a plurality of managed computer systems;
a management gateway coupled to the plurality of managed computer systems through a remote management client;
a portal webserver coupled to the management gateway and configured to grant access to the plurality of managed systems and to provide a layered display to a user device, the display comprising an upper layer of management instructions for a first one of the managed systems and a lower layer of content from the first managed system.

14. The computer management system of claim 13, wherein the portal webserver is configured to cause the upper layer to be movable within the display.

15. The computer management system of claim 13, wherein the portal webserver is configured to provide the layered display through a web browser.

16. The computer management system of claim 13, wherein the portal webserver is configured to provide the layered display using a hypertext transfer protocol.

16. The computer management system of claim 13, wherein the portal webserver is configured to:
provide a selection of one or more second managed computer systems in the upper layer; and
upon selection of one of the second managed computer systems:
provide management instructions for the selected second managed computer system in the upper layer of the display; and
provide a user interface of the selected second managed computer system in the lower level of the display.

17. The computer management system of claim 16, wherein the processor and program code are configured to cause the apparatus to provide a single logon for the first managed computer system and the second managed computer systems.
